(19) United States
(12) Patent Application Publication
(10) Pub. No.: US 2004/0079404 A1
(43) Pub. Date: Apr. 29, 2004

(54) Pathological waste disposal unit

(76) Inventor: Bruce Robert Burrows, Kallangur (AU)

Correspondence Address: STONEMAN LAW OFFICES, LTD, 3113 NORTH 3RD STREET, PHOENIX, AZ, 85012, US

(21) Appl. No.: 10/468,985

(22) PCT Filed: Feb. 26, 2002
(86) PCT No.: PCT/AU02/00205

(30) Foreign Application Priority Data
Feb. 26, 2001 (AU) PR 3351

(51) Int. Cl. B08B 7/00; B08B 3/00

(52) U.S. Cl. 134/200; 134/170; 134/153; 134/16; 134/33; 134/34

(57) ABSTRACT

A pathological waste disposal unit (10) has a chamber (11) with a closeable cover (16) and a waste outlet (14) connected to a waste sump (20). A carrier (30) for waste bags (40) is mounted on a shaft (31), rotatable by an impellor (30), on which is directed high pressure water from nozzles (150). Water knives (70) cut open the waste bags (40) while the carrier (30) is rotating to release the waste (41) from the waste bags (40), to cause the waste to face the bottom wall (13) of the chamber (11) and flow through the waste outlet (14) to the waste sump (20). Safety interlock means prevent operation of the unit (10) while the cover (16) is raised and the opening of the cover (16) while the unit (10) is in operation.

### BACKGROUND OF THE INVENTION

1. Field of the Invention

THIS INVENTION relates to a pathological waste disposal unit.

The term “pathological waste” shall be used to include urine, faeces, other body fluids, pus, and other waste and/or infectious materials. While the invention is primarily directed to the disposal of such waste from humans, the waste may be obtained from animals, birds or other living creatures.

2. Prior Art

The use of disposable waste bags, eg., urine bags, colostomy bags and wound drainage bags is increasing throughout Australia and the world. For example, in some geriatric nursing and care institutions, patients are provided with one or more urine collection bags each day.

The disposal of pathological waste bags is expensive, and the bags are typically dumped in sealed containers, taking up useful waste-fill space. If the bags become damaged, the waste can uncontrollably leech through the soil into water courses or ground water.

### SUMMARY OF THE INVENTION

It is an object of the present invention to provide a pathological waste disposal unit where the collected waste can be easily removed from the bags for (optional) waste treatment.

It is a preferred object to provide such a unit where the waste bags, when emptied, can be collected for storage or destruction.

It is a further preferred object of the present invention to provide such a disposal unit where the operator's safety can be ensured to minimise the potential for infection by coming into contact with the waste.

It is a still further preferred object to provide a unit which can be operated without the need for an electrical power supply.

Other preferred objects of the present invention will become apparent from the following description.

In one aspect, the present invention resides in a pathological waste disposal unit including:

a disposal chamber having a closeable cover;

a waste bag carrier rotatably mounted in the chamber, having means to support a plurality of disposable waste bags;

means to rotate the carrier;

means to release the waste(s) from the waste bags;

washing means to clean the waste(s) from the waste bags; and

waste outlet means in the chamber to enable disposal of the waste(s) to a collection location or sump.

Preferably, the disposal chamber (and the cover) are formed from stainless steel or suitable plastics materials. Preferably, the chamber has a cylindrical side wall and a bottom wall or floor curved, or downwardly convergent, to the waste outlet means. (The waste outlet means may be connected, eg., by an S-trap to a sump, waste collection location or to waste treatment means).

Preferably, the closeable cover is hingedly mounted on the side wall and incorporates safety operating means which prevent the disposal unit operating while the cover is raised.

Preferably, the waste bag carrier is rotatably mounted in the chamber, co-axially with the wall, on a support shaft via suitable bearings and/or bushings. A plurality of hook, clip or other support means may be provided on the carrier to releasably support the waste bags.

The means to rotate the carrier may include an impellor into which is directed one or more jets of high-pressure water via one or more water nozzles. Alternatively, the carrier may be mounted on a shaft, rotatably journalled in the bottom wall of the chamber, and driven, either directly or indirectly, by an electric motor, hydraulic motor, pneumatic motor or the like.

Means to release the waste from the water bags may include a high pressure water “knife”, or knives or one or more retractable mechanical knives, in the chamber, which cut open the waste bags (preferably adjacent the bottom of the bags). The water knife, or knives, are formed by high pressure, concentrated, water jets operable to cut the waste bags.

The washing means to clean the waste from the waste bags may include one or more water nozzles (eg., the water knife/knives) in the chamber.

Timer means may control respective valves which control the flow of water to (a) the high pressure nozzle(s) directed at the impellor and to (b) the water knife/knives. Water may be supplied from a source via one or more pressure pumps.

### BRIEF DESCRIPTION OF THE DRAWINGS

To enable the invention to be fully understood, a preferred embodiment will now be described with reference to:

FIG. 1 which is a schematic sectional side view of a first embodiment of the disposal unit;

FIG. 2 which is a schematic sectional side view of a second embodiment, with the cover closed;

FIG. 3 which is a similar view with the cover raised;

FIG. 4 is a part-sectional schematic isometric view of a third embodiment;

FIG. 5 is a top plan view of the third embodiment; and

FIG. 6 is a sectional front elevational view taken on line A-A on FIG. 5.

### DETAILED DESCRIPTION OF THE PREFERRED EMBODIMENTS

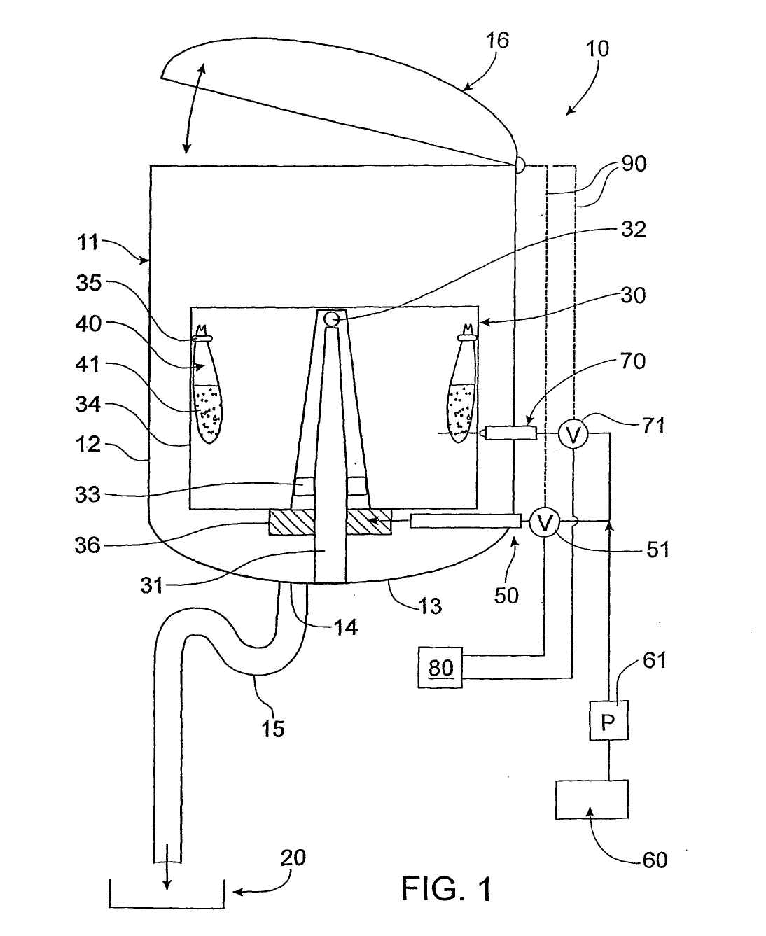

The disposal unit 10, of the first embodiment shown in FIG. 1, is manufactured from stainless steel and has a disposal chamber 11 with a cylindrical side wall 12 and a (convexly) curved bottom wall 13. A waste outlet 14, in the bottom wall 13, is connected via an S-trap 15 to convey the waste to a collection point or sump 20. (An annular channel (not shown) in the bottom wall 13 may be connected to the waste outlet 14.)

A cover 16 is hingedly mounted on the side wall 12 and is operable to be moved between a raised position to enable the waste bags to be loaded into, or removed from, the disposal chamber 11, and a closed position during operation of the disposal unit 10.

A waste bag carrier 30 is mounted on a central shaft 31 for rotation co-axial with the side wall 12 of the chamber 11. The carrier 30 is rotatably journalled on the shaft 31 via a ball-bearing 32 and (eg., nylon) bushes 33.

The carrier 30 has a frame 34 on which is provided a plurality of hooks, clips, clamps or the like 35 to releasably support disposable waste bags 40 containing the pathological waste 41 (eg., urine and/or faeces).

The carrier 30 has an impellor (or turbine) 36 mounted co-axially on the underside of the carrier frame 34 and is operably rotated by a high pressure water jet directed onto the impellor 36 via a water nozzle 50, the nozzle 50 being connected to a water source 60 via a pressure pump 61 and a valve 51.

The waste bags 40 are opened by high pressure water jets from one or more water knives 70 provided in the chamber 11, the knives being connected to the pressure pump 61 via valve(s) 71. (For a plurality of knives, a single valve can direct flow to a manifold connected to the knives.)

The respective operations of the valves 51, 71 are controlled via a timer unit 80, and the valves 51, 71 are closed by a safety mechanism 90 which shuts off the valves 51, 71 whenever the cover 16 is raised. (The safety unit 90 can also be connected to a braking system (not shown) for the carrier 30.

The operation of the disposal unit 10 will now be described.

The cover 16 is raised and the waste disposal bags 40 (containing the pathological waste 41) are mounted on the carrier 30 via the hooks or clips 35.

The lid 16 is closed, and the timer 80 opens the valve 51 to enable water to be directed onto the impellor 36, to thereby rotate the carrier 30 at a relatively high rotational speed. The timer 80 also opens the valve(s) 71 on the water knife/knives 70, which cut open the waste bags 40, releasing the waste 41. The combination of the water (from the nozzle 50 and knives 70) and centrifugal force generated by the rotation of the carrier 30 releases the waste 41 from the bags 40 and causes it to flow onto the bottom wall 13 of the chamber 11, and then out the waste outlet 14 (via the S-trap 15) to the collection point or sump 20. (The waste 41 collected in the collection point or sump 20 may be subject to one or more treatment processes, eg., to enable the water from the waste 41 to be safely returned to a water system.)

While the carrier 30 may be rotatably mounted on the shaft 31, and rotated by water pressure on the impellor 36, the carrier 30 may be mounted on a rotary shaft, journalled in the bottom wall 13 of the chamber 11, and driven directly (or indirectly, eg., by belts and pulleys or sprockets and chains) by an electric motor, hydraulic motor, pneumatic motor or the like. With such an arrangement, suitable sealing means must be provided between the rotary shaft and the bottom wall 13 of the disposal chamber 11.

As an alternative to the water knife or knives 70, one or more retractable mechanical knives (not shown), with blades fitted to pneumatic rams at 70, may be provided in the chamber 11, to cut open the waste bags 40 to release the waste 41. Preferably, the mechanical knives will have an interlock which will ensure that they are retracted whenever the carrier 30 is being rotated (and/or when the cover 16 is raised).

When the cleaning cycle has been completed, the operator can open the cover 16 and remove the (now empty) waste bags 40 from the chamber 11 for suitable disposal. Clearly, the volume of material (ie., the empty waste bags 40) to be disposed of is much less than with the volume of the full waste bags.

It will be readily apparent to the skilled addressee that the components of the unit 10 will preferably be manufactured from materials which are not subject to the corrosive effects of the waste and such materials may include stainless steel, other steel alloys, glass reinforced plastics, injection moulded plastics or other plastics materials.

Where a source of high pressure water is available, eg., from a reticulated supply, the pressure pump 61 may be omitted.

If a mechanical timer is provided, no source of electrical power is required and the disposal unit 10 may be used in remote locations where resources are limited.

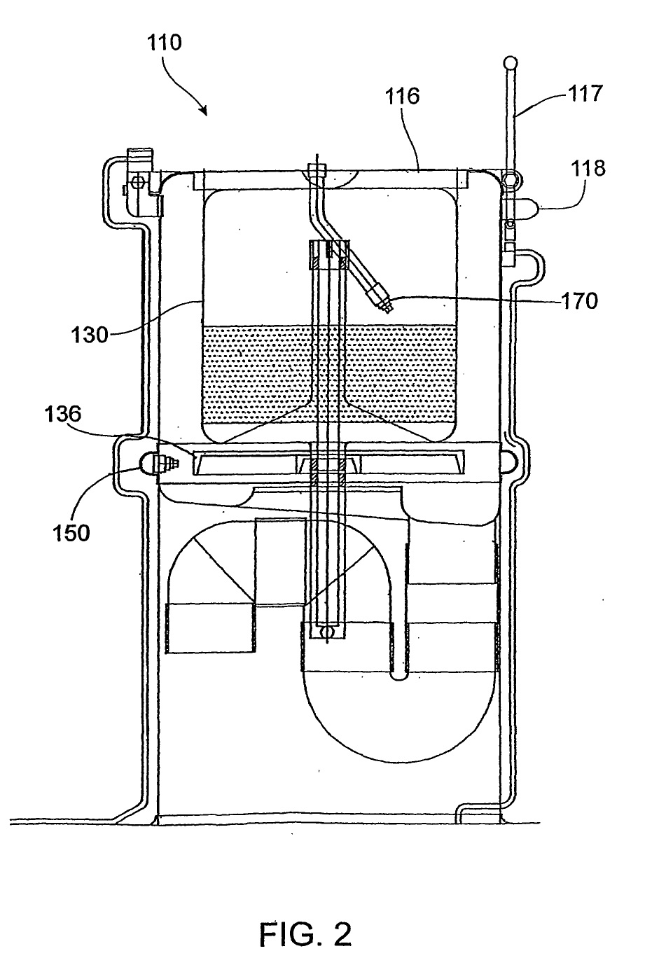

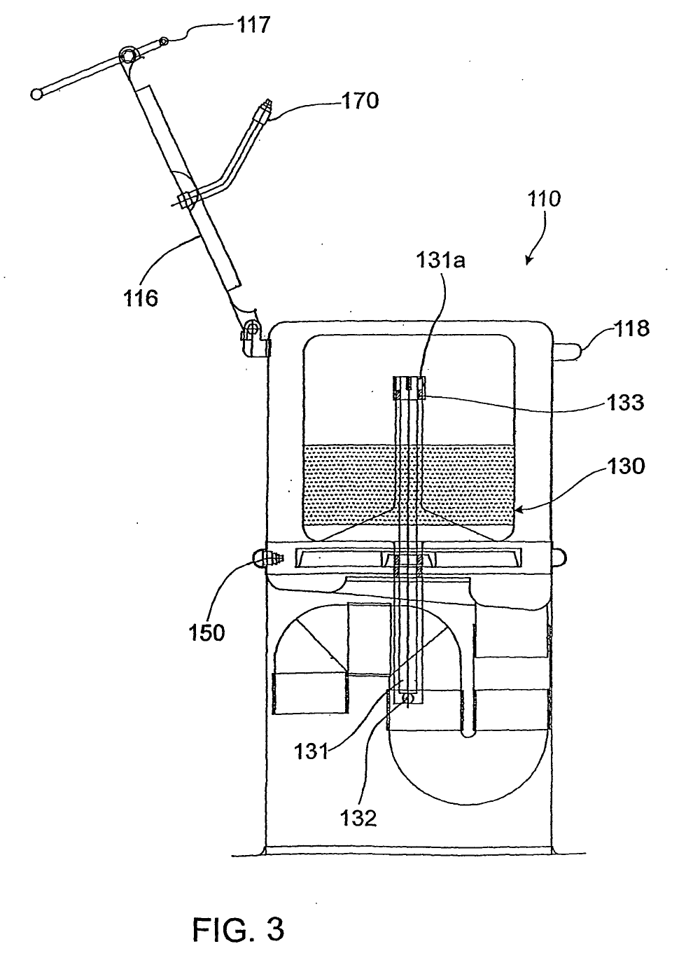

Referring to FIGS. 2 and 3, the disposal unit 110 of the second embodiment is generally similar to the disposal unit 10 of FIG. 1.

The water knife 170 is mounted in the cover 116 and is connected to a high pressure pump (not shown). The nozzle 150, which drives the impellor 136 on the carrier 130, is connected to the water source via a valve (not shown) which is controlled by the handle 117 which releasably locks the cover 116 closed. The handle 117 also operates a valve (not shown) which isolates the water knife 170 when the cover 116 is raised (see FIG. 3). A solenoid 118 prevents the handle 117 being operated, to open the cover 16, while the unit 110 is in operation, ie., while the water knife 170 is operating or the carrier 130 is rotating.

In this embodiment, the carrier 130 is releasably connected to the shaft 131 via a cap 131a, the shaft 131 being journalled in bushes 133 in the inner side wall of the chamber 111, the shaft 131 being supported at its lower end on a ball-bearing 132.

As the cover 116 cannot be raised while the unit 110 is operating, and the opening of the cover 116 shuts off the valve supplying the water to the nozzle 150 and water knife 170, maximum operation safety is ensured.

The solenoid 118 can also be set so that it will not allow the handle 117 to be operated (to open the cover 116) until a preset time (eg., 2 minutes) after the valves for the nozzle 150 and water knife 170 have been shut off, the allow the carrier 130 to stop rotating. This avoids the need for a braking mechanism for the carrier 130.

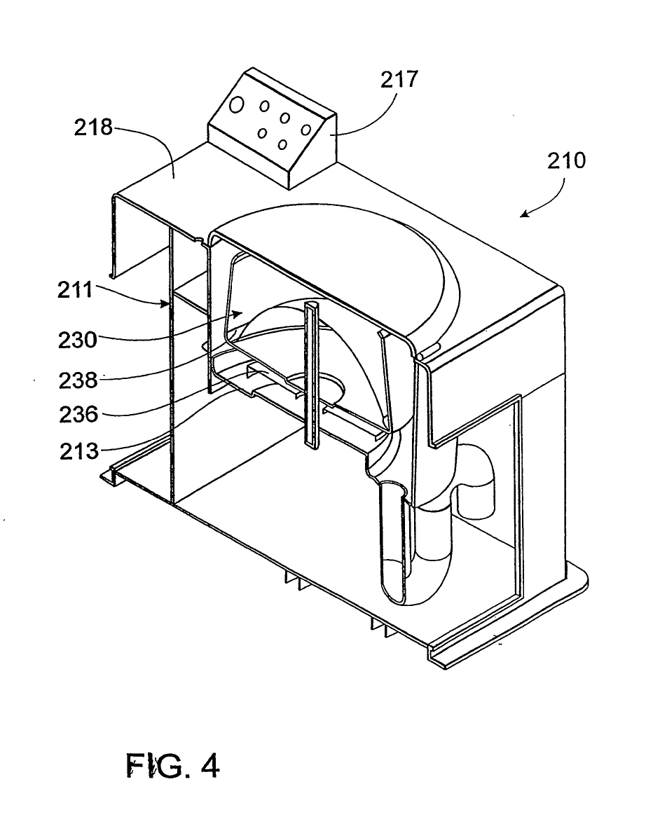

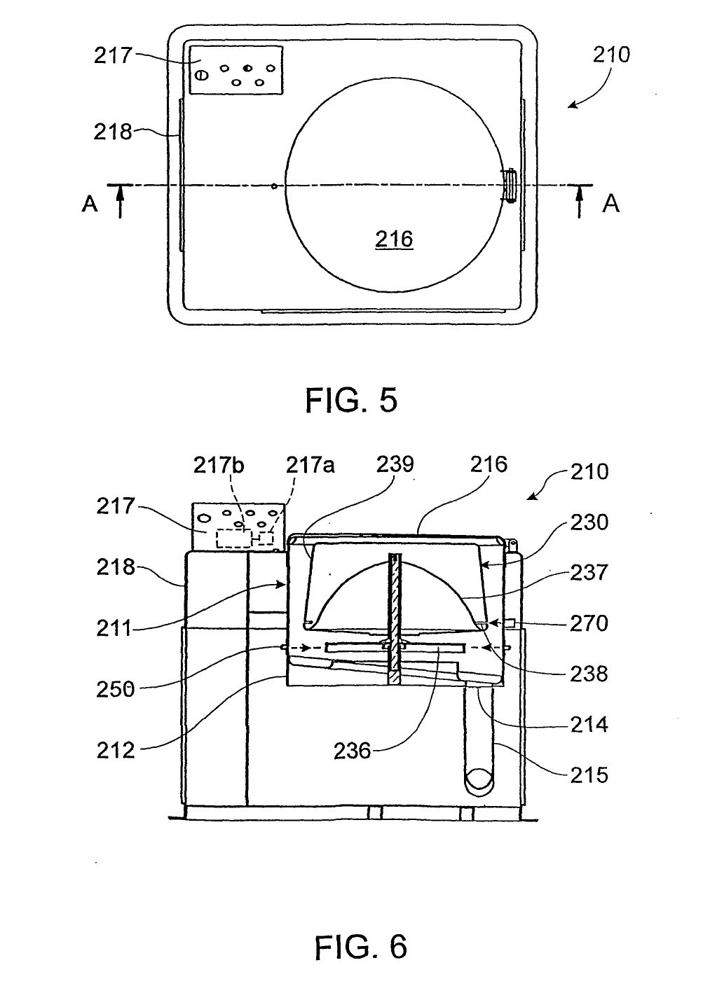

Referring to FIGS. 4 to 6 of the third embodiment 210, the carrier 230 is a drum with a convex bottom wall 237 mounted on the shaft 231, driven by the impellor 236. Slots 238 in the side wall 239 allow the water jets from the water knives 270 (within the chamber 211) to cut open the waste bags (not shown).

The impellor 236 is driven by the water jets from water nozzles 250 mounted in the side wall 212 of the chamber 211. The bottom wall 213 of the chamber 211 is formed by an inclined trough to direct the waste/water to a waste outlet 214 and trap 215 to a collection point or sump (not shown).

As hereinbefore described, the cover 216 has a safety interlock means to prevent operation of the unit until the cover 216 is closed, and prevent the cover from being opened until the wash cycle is completed and the carrier drum 230 is no longer rotating.

The operation of the unit 210, including the timer means 217a, can be controlled by a computer 217b, and the required cycles selected via a control panel 217 on the top of the unit casing 218.

To reduce the cycle time, an extra water nozzle, controlled by a solenoid valve, can be directed at the impellor (or turbine) 36, 136, 236 to apply a braking force to the carrier 30, 130, 230 when the wash cycle is completed.

Various changes and modifications may be made to the embodiments described and illustrated without departing from the present invention.

1. A pathological waste disposal unit including:
a disposal chamber having a closeable cover;
a waste bag carrier rotatably mounted in the chamber, having means to support a plurality of disposable waste bags;
means to rotate the carrier;
means to release the waste(s) from the waste bags;
washing means to clean the waste(s) from the waste bags; and
waste outlet means in the chamber to enable disposal of the waste(s) to a collection location or sump.

2. A unit as claimed in claim 1, wherein:
the disposal chamber and the cover are formed from stainless steel or suitable plastics materials.

3. A unit as claimed in claim 2 wherein:
the chamber has a cylindrical side wall, and a bottom wall or floor curved, or downwardly convergent, to the waste outlet means.

4. A unit as claimed in claim 3 wherein:
the waste outlet means is connected by an S-trap to a sump, waste collection location or to waste treatment means.

5. A unit as claimed in claim 3 wherein:
the closeable cover is hingedly mounted on the side wall and incorporates safety operating means, such as a solenoid, which prevents the disposal unit operating while the cover is raised, and/or prevents the cover being raised while the disposal unit is operating.

6. A unit as claimed in any one of claims 3 to 5 wherein:
the waste bag carrier is rotatably mounted in the chamber, co-axially with the side wall, on a support shaft via suitable bearings and/or bushings, and a plurality of hook, clip or other support means are provided on the carrier to releasably support the waste bags.

7. A unit as claimed in any one of claims 3 to 6 wherein:
the means to rotate the carrier includes an impellor into which is directed one or more jets of high-pressure water via one or more water nozzles.

8. A unit as claimed in any one of claims 3 to 6 wherein:
the carrier is mounted on a shaft, rotatably journalled in the bottom wall of the chamber, and driven, either directly or indirectly, by an electric motor, hydraulic motor, pneumatic motor or the like.

9. A unit as claimed in any one of claims 1 to 8 wherein:
the means to release the waste from the water bags includes a high pressure water “knife”, or knives, or one or more retractable mechanical knives, in the chamber, which cut open the waste bags adjacent the bottom of the bags.

10. A unit as claimed in any one of claims 1 to 9 wherein:
the washing means to clean the waste from the waste bags includes one or more water nozzles in the chamber.

11. A unit as claimed in any one of claims 1 to 10 wherein:
timer means control respective valves which control the flow of water to (a) the high pressure nozzle(s) directed at the impellor and to (b) the water knife/knives.

12. A unit as claimed in claim 10 wherein:
water is supplied from a source via one or more pressure pumps.
